(19) United States
(12) Patent Application Publication
(10) Pub. No.: US 2026/0094235 A1
(43) Pub. Date: Apr. 2, 2026

(54) DISPLAY CONTROL DEVICE AND DISPLAY CONTROL METHOD

(71) Applicant: Panasonic Automotive Systems Co., Ltd., Kanagawa (JP)

(72) Inventors: Takami YAMAMOTO, Osaka (JP); Nobutaka KITAJIMA, Osaka (JP); Junya YUSA, Kanagawa (JP); Masahito OISHI, Kanagawa (JP)

(73) Assignee: Panasonic Automotive Systems Co., Ltd., Kanagawa (JP)

(21) Appl. No.: 19/412,377

(22) Filed: Dec. 8, 2025

Related U.S. Application Data
(63) Continuation of application No. PCT/JP2024/028448, filed on Aug. 8, 2024.

(30) Foreign Application Priority Data
Sep. 13, 2023 (JP) 2023-148827

(51) Int. Cl. G06T 3/40; B60K 35/22; B60K 35/65; B60K 35/81; B60R 1/25; B60R 1/26; G06F 3/14

(52) U.S. Cl. CPC G06T 3/40; B60K 35/22; B60K 35/654; B60K 35/81; B60R 1/25; B60R 1/26; G06F 3/1423; B60K 2360/176; B60K 2360/182; B60K 2360/186; B60R 2300/207; B60R 2300/30

(57) ABSTRACT

A display control device includes: an obtainer that obtains a driving status of a vehicle; a determiner that determines, on the basis of the driving status obtained by the obtainer, whether to enlarge a first image cropped from a captured image of a rearward area of the vehicle and displayed on a display located in the vehicle; and a controller that, when the determiner determines that the first image is to be enlarged, enlarges the first image by enlarging a cropping area to crop the first image from the captured image, and causes the display to display the enlarged first image.

### CROSS REFERENCE TO RELATED APPLICATIONS

This is a continuation application of PCT International Patent Application No. PCT/JP2024/028448 filed on Aug. 8, 2024, designating the United States of America, which is based on and claims priority of Japanese Patent Application No. 2023-148827 filed on Sep. 13, 2023.

### FIELD

The present disclosure relates to, for example, a display control device.

### BACKGROUND

For example, a device that controls display of an image on a display located in a vehicle is conventionally disclosed. For instance, Patent Literature (PTL) 1 discloses a vehicle rear-view monitoring system including (i) an image processor that acquires and processes images captured by rear-view cameras, and generates an overhead image of a vehicle's surrounding area with different perspectives and (ii) a monitoring system that displays the overhead image on a monitor screen. In the vehicle rear-view monitoring system disclosed in PTL 1, side-view cameras that each capture a rearward area of a vehicle are provided, one on or near the left door mirror of the vehicle and one on or near the right door mirror of the vehicle, and both images captured by the side-view cameras and an overhead image are displayed on the monitor screen at once.

### CITATION LIST

### Patent Literature

PTL 1: Japanese Unexamined Patent Application Publication No. 2003-219413

### SUMMARY

However, the vehicle rear-view monitoring system disclosed in PTL 1 can be improved upon.

In view of this, the present disclosure provides a display control device and so forth capable of improving upon the above related art.

A display control device according to one aspect of the present disclosure includes: an obtainer that obtains a driving status of a vehicle; a determiner that performs determination processing, based on the driving status obtained by the obtainer, for determining whether to enlarge a first image to generate an enlarged first image, the first image being cropped from a captured image of a rearward area of the vehicle and displayed on a display located in the vehicle; and a controller that performs, when the determination processing determines that the first image is to be enlarged, display control to enlarge the first image by enlarging a cropping area to crop the first image from the captured image, and to display the enlarged first image on the display.

Moreover, a display control method according to another aspect of the present disclosure includes: obtaining a driving status of a vehicle; determining, based on the driving status obtained in the obtaining, whether to enlarge a first image cropped from a captured image of a rearward area of the vehicle and displayed on a display located in the vehicle; and when the determining determines that the first image is to be enlarged, enlarging the first image by enlarging a cropping area to crop the first image from the captured image, and causing the display to display the first image enlarged.

Moreover, a program according to another aspect of the present disclosure is a program for causing a computer to perform the above display control method.

It should be noted that these general or specific aspects may be achieved as a system, a method, an integrated circuit, a computer program, or a computer-readable recording medium such as a CD-ROM or may be achieved as any combination of the system, method, integrated circuit, computer program, and recording medium. Moreover, the recording medium may be a non-transitory recording medium.

A display control device and so forth in the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram of a vehicle including a display control device according to an embodiment.

FIG. 2 is a block diagram illustrating functional configurations of the display control device and so forth in FIG. 1.

FIG. 3 is a flowchart illustrating an example of a display control method performed by the display control device in FIG. 1.

FIG. 4 is a figure for explaining a first operation example of the display control device in FIG. 1.

FIG. 5 is a figure for explaining a second operation example of the display control device in FIG. 1.

FIG. 6 is a figure for explaining a third operation example of the display control device in FIG. 1.

FIG. 7 is a figure for explaining a fourth operation example of the display control device in FIG. 1.

FIG. 8 is a figure for explaining a fifth operation example of the display control device in FIG. 1.

FIG. 9 is a figure for explaining a sixth operation example of the display control device in FIG. 1.

FIG. 10 is a figure for explaining a seventh operation example of the display control device in FIG. 1.

FIG. 11 is a figure for explaining an eighth operation example of the display control device in FIG. 1.

FIG. 12 is a figure for explaining a ninth operation example of the display control device in FIG. 1.

### DESCRIPTION OF EMBODIMENT

The vehicle rear-view monitoring system disclosed in the above-mentioned PTL 1 can select the field of view to crop from images captured by the side-view cameras, but cannot enlarge a cropping area. Thus, it is difficult to check a rearward area of a vehicle. In view of this, the present disclosure provides a display control device and so forth that can make it easier to check a rearward area of a vehicle.

A display control device according to one aspect of the present disclosure includes: an obtainer that obtains a driving status of a vehicle; a determiner that performs determination processing, based on the driving status obtained by the obtainer, for determining whether to enlarge a first image to generate an enlarged first image, the first image being cropped from a captured image of a rearward area of the vehicle and displayed on a display located in the vehicle; and a controller that performs, when the determination processing determines that the first image is to be enlarged, display control to enlarge the first image by enlarging a cropping area to crop the first image from the captured image, and to display the enlarged first image on the display.

In this way, it is possible to enlarge the first image by enlarging the cropping area to crop the first image from the captured image of the rearward area of the vehicle, and display the enlarged first image on the display. Thus, it is possible to see a wider view of the rearward area of the vehicle, which makes it easier to check the rearward area of the vehicle.

Moreover, in the display control device according to the aspect of the present disclosure, the captured image may be an image of a rearward area on one side in a lateral direction of the vehicle, the display may include a first display that is located in front of a driver's seat in the vehicle in a longitudinal direction of the vehicle and located to the one side of a central area in the lateral direction, and displays an image viewable from the driver's seat, when the vehicle is about to move to the one side or is about to move backward, the determiner may determine that the first image displayed on the first display is to be enlarged, and when the determiner determines that the first image is to be enlarged, the controller may enlarge the first image by enlarging the cropping area, and cause the first display to display the enlarged first image.

In this way, when the vehicle is about to move to the one side or is about to move backward, it is possible to display the enlarged first image on the first display. Thus, when the vehicle is about to move to the one side or is about to move backward, it is possible to easily see a wider view of the rearward area on the one side of the vehicle, which makes it even easier to check the rearward area of the vehicle.

Moreover, in the display control device according to the aspect of the present disclosure, the display may include a second display that is located in the central area and located to an other side in the lateral direction of the first display, and displays an image viewable from the driver's seat, when the vehicle is about to move to the one side, the determiner may determine that the first image displayed on the first display is to be enlarged, and when the determiner determines that the first image is to be enlarged, the controller may enlarge the first image by extending the cropping area to the one side, and cause the enlarged first image to be displayed across the first display and the second display.

In this way, when the vehicle is about to move to the one side, it is possible to display the enlarged first image across the first display and the second display. Thus, when the vehicle is about to move to the one side, it is possible to more easily see a wider view of the rearward area on the one side of the vehicle, which makes it even easier to check the rearward area of the vehicle.

Moreover, in the display control device according to the aspect of the present disclosure, when the enlarged first image is to be displayed across the first display and the second display, if the second display is displaying a second image, the controller may reduce the second image to generate a reduced second image by shrinking at least a portion of the second image in the lateral direction, and cause the reduced second image to be displayed on a region, within the second display, where the first image is not displayed.

In this way, the second image as well as the enlarged first image can be displayed without removing the second image. Thus, it is possible to suppress the amount of information obtained from the second image from decreasing and make it easier to check the rearward area of the vehicle.

Moreover, in the display control device according to the aspect of the present disclosure, when the enlarged first image is to be displayed across the first display and the second display, if the second display is displaying a second image, the controller may reduce the second image to generate a reduced second image by removing a portion of the second image from the second display, and cause the reduced second image to be displayed on a region, within the second display, where the first image is not displayed.

In this way, the second image as well as the enlarged first image can be displayed without reducing the scale of an unremoved portion of the second image. Thus, it is possible to easily see the unremoved portion of the second image and make it easier to check the rearward area of the vehicle.

Moreover, in the display control device according to the aspect of the present disclosure, when the enlarged first image is to be displayed across the first display and the second display, if the second display is displaying a second image including images arranged in the lateral direction, the controller may reduce the second image to generate a reduced second image by shrinking the images in a vertical direction of the vehicle and arranging the images in the vertical direction, and cause the reduced second image to be displayed on a region, within the second display, where the first image is not displayed.

In this way, the second image as well as the enlarged first image can be displayed without removing the second image. Thus, it is possible to suppress the amount of information obtained from the second image from decreasing and make it easier to check the rearward area of the vehicle.

Moreover, in the display control device according to the aspect of the present disclosure, when the enlarged first image is to be displayed across the first display and the second display, if the second display is displaying a second image, the controller may superimpose, onto the second image, a portion of the enlarged first image that is to be displayed on the second display, and cause the second display to display the second image onto which the portion is superimposed.

In this way, the second image as well as the enlarged first image can be displayed without reducing the scale of the portion of the second image that is not superimposed with the first image. Thus, it is possible to easily see the portion of the second image that is not superimposed with the first image and make it easier to check the rearward area of the vehicle.

Moreover, in the display control device according to the aspect of the present disclosure, the display may include a third display that is located to the other side in the lateral direction of the second display, and displays an image viewable from the driver's seat, and when the enlarged first image is to be displayed across the first display and the second display, if the second display is displaying a second image, and the third display is displaying a third image, the controller: may cause the second image to be displayed across the third display and a region, within the second display, where the first image is not displayed; and may reduce the third image to generate a reduced third image by removing a portion of the third image from the third display, and cause the reduced third image to be displayed on a region, within the third display, where the second image is not displayed.

In this way, the second image and the third image as well as the enlarged first image can be displayed without removing the second image or reducing the scale of an unremoved portion of the third image. Thus, it is possible to suppress the amount of information obtained from the second image from decreasing, easily see the unremoved portion of the third image, and make it easier to check the rearward area of the vehicle.

Moreover, in the display control device according to the aspect of the present disclosure, the display may include a fourth display that is located to the one side in the lateral direction of the first display, and displays an image viewable from the driver's seat, when the vehicle is about to move to the one side, the determiner may determine that the first image displayed on the first display is to be enlarged, and when the determiner determines that the first image is to be enlarged, the controller may enlarge the first image by extending the cropping area to the one side, and cause the enlarged first image to be displayed across the first display and the fourth display.

In this way, when the vehicle is about to move to the one side, it is possible to display the enlarged first image across the first display and the fourth display. Thus, when the vehicle is about to move to the one side, it is possible to more easily see a wider view of the rearward area on the one side of the vehicle, which makes it even easier to check the rearward area of the vehicle.

Moreover, in the display control device according to the aspect of the present disclosure, the display may include a fifth display that is located on a lower side of the first display in a vertical direction of the vehicle, and displays an image viewable from the driver's seat, when the vehicle is about to move backward, the determiner may determine that the first image displayed on the first display is to be enlarged, and when the determiner determines that the first image is to be enlarged, the controller may enlarge the first image by extending the cropping area to the lower side, and cause the enlarged first image to be displayed across the first display and the fifth display.

In this way, when the vehicle is about to move backward, it is possible to display the enlarged first image across the first display and the fifth display. Thus, when the vehicle is about to move backward, it is possible to more easily see a wider view of the rearward area on the one side of the vehicle, which makes it even easier to check the rearward area of the vehicle.

Moreover, in the display control device according to the aspect of the present disclosure, the captured image may be an image of a rearward area of the vehicle, the display may include: a sixth display that is located in front of a driver's seat in the vehicle in a longitudinal direction of the vehicle and located in a central area in a lateral direction of the vehicle, and displays an image viewable from the driver's seat; and a seventh display that is located in front of the driver's seat in the longitudinal direction, located in the central area, and located above the sixth display in a vertical direction of the vehicle, is smaller than the sixth display, and displays an image viewable from the driver's seat, when the vehicle is about to move backward, the determiner may determine that the first image displayed on the seventh display is to be enlarged, and when the determiner determines that the first image is to be enlarged, the controller may enlarge the first image by enlarging the cropping area, and cause the sixth display to display the enlarged first image.

In this way, when the vehicle is about to move backward, it is possible to display the enlarged first image on the sixth display. Thus, when the vehicle is about to move backward, it is possible to easily see a wider view of the rearward area of the vehicle, which makes it even easier to check the rearward area of the vehicle.

Moreover, a display control method according to another aspect of the present disclosure includes: obtaining a driving status of a vehicle; determining, based on the driving status obtained in the obtaining, whether to enlarge a first image cropped from a captured image of a rearward area of the vehicle and displayed on a display located in the vehicle; and when the determining determines that the first image is to be enlarged, enlarging the first image by enlarging a cropping area to crop the first image from the captured image, and causing the display to display the first image enlarged.

The display control method has an advantage similar to that of the above display control device.

Moreover, a program according to another aspect of the present disclosure is a program for causing a computer to perform the above display control method.

The program has an advantage similar to that of the above display control device.

Embodiments are described below in detail with reference to the drawings.

It should be noted that the embodiments described below each indicate a comprehensive or specific example. The numerical values, shapes, materials, constituent elements, arrangement and connection of the constituent elements, steps, order of steps, and other details indicated in the embodiments described below are merely examples, and do not intend to limit the present disclosure. Moreover, among the constituent elements described in the embodiments below, those not recited in any of the independent claims are described as optional constituent elements. Moreover, the figures are schematic illustrations and are not necessarily precise depictions. Moreover, identical constituent elements are assigned the same reference sign in the figures.

### Embodiment

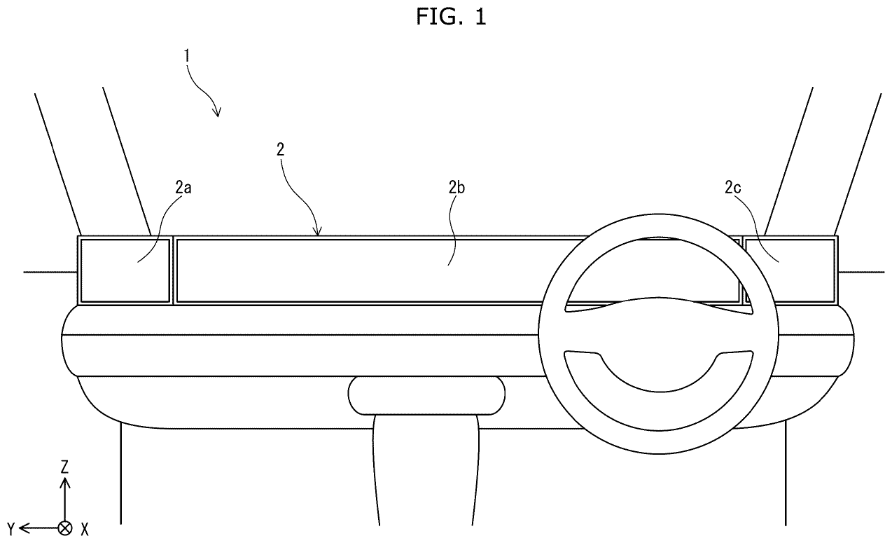

FIG. 1 is a schematic diagram of vehicle 1 including display control device 10 (described later) according to an embodiment. First, vehicle 1 is described with reference to FIG. 1.

In FIG. 1, an X-axis direction indicates a longitudinal direction of vehicle 1, the positive side of the X-axis direction indicates the front side, and the negative side of the X-axis direction indicates the rear side. Moreover, a Y-axis direction indicates a lateral direction of vehicle 1, the positive side of the Y-axis direction indicates the left side, and the negative side of the Y-axis direction indicates the right side. Moreover, a Z-axis direction indicates a vertical direction of vehicle 1, the positive side of the Z-axis direction indicates the upper side, and the negative side of the Z-axis direction indicates the lower side.

Hereinafter, the longitudinal direction of vehicle 1 may be simply referred to as the longitudinal direction. Moreover, the lateral direction of vehicle 1 may be simply referred to as the lateral direction. Moreover, the vertical direction of vehicle 1 may be simply referred to as the vertical direction.

As illustrated in FIG. 1, display 2 that displays an image is located in vehicle 1. Vehicle 1 is, for example, an automobile. Display 2 includes display 2a, display 2b, and display 2c. Display 2a, display 2b, and display 2c are located in a compartment of vehicle 1 and are physically separate from each other.

Display 2a is located in front of a driver's seat in vehicle 1 in the longitudinal direction. The driver's seat in vehicle 1 is located to the right of a central area in the lateral direction of vehicle 1. Display 2a is located to the left of the central area in the lateral direction of vehicle 1. Display 2a is located to the left of display 2b. In the embodiment, display 2a is located in a left end portion of a dashboard of vehicle 1. Display 2a displays an image viewable from the driver's seat in vehicle 1. That is, a driver seated in the driver's seat in vehicle 1 can see the image displayed on display 2a. In display 2a, a display screen for displaying an image faces the driver's seat in vehicle 1. For instance, display 2a is a left-side electronic side-view mirror.

Display 2b is located in front of the driver's seat in vehicle 1 in the longitudinal direction. Display 2b is located in the central area in the lateral direction of vehicle 1. Display 2b is located to the right of display 2a. Display 2b is located to the left of display 2c. Display 2b extends in the lateral direction from the front of the driver's seat in vehicle 1 to the front of a passenger seat in vehicle 1. A left end portion of display 2b is adjacent to a right end portion of display 2a. A right end portion of display 2b is adjacent to a left end portion of display 2c. In the embodiment, display 2b is located in the central area of the dashboard of vehicle 1. Display 2b displays an image viewable from the driver's seat in vehicle 1. That is, a driver seated in the driver's seat in vehicle 1 can see the image displayed on display 2b. In display 2b, a display screen for displaying an image is parallel to the vertical direction and the lateral direction, and faces backward in the longitudinal direction.

Display 2c is located in front of the driver's seat in vehicle 1 in the longitudinal direction. Display 2c is located to the right of the central area in the lateral direction of vehicle 1. Display 2c is located to the right of the driver's seat in vehicle 1 in the lateral direction. Display 2c is located to the right of display 2b. In the embodiment, display 2c is located in a right end portion of the dashboard of vehicle 1. Display 2c displays an image viewable from the driver's seat in vehicle 1. That is, a driver seated in the driver's seat in vehicle 1 can see the image displayed on display 2c. In display 2c, a display screen for displaying an image faces the driver's seat in vehicle 1. For instance, display 2c is a right-side electronic side-view mirror.

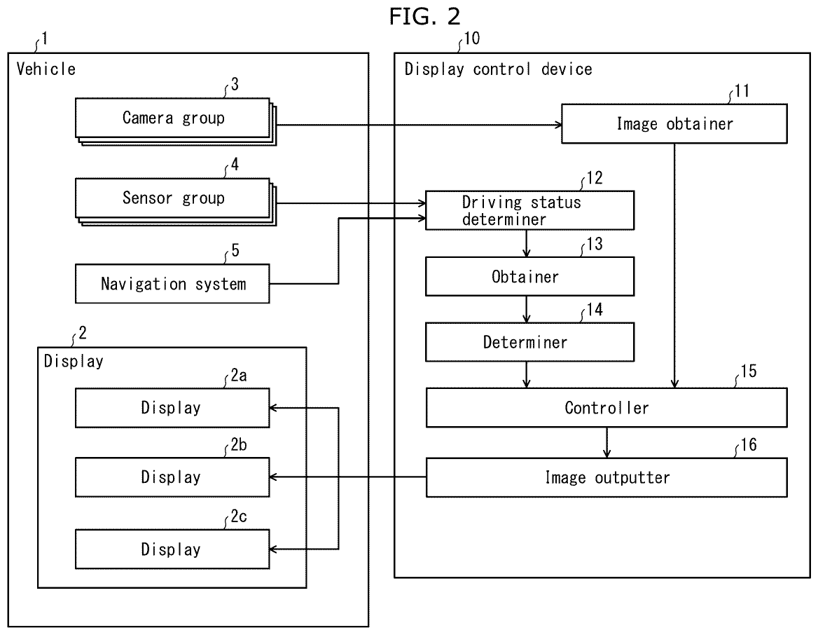

FIG. 2 is a block diagram illustrating functional configurations of display control device 10 and so forth in FIG. 1. Next, functional configurations of vehicle 1 and display control device 10 are described with reference to FIG. 2.

As illustrated in FIG. 2, vehicle 1 includes camera group 3, sensor group 4, and navigation system 5.

Camera group 3 images a rearward area of vehicle 1. The rearward area of vehicle 1 includes an area behind vehicle 1, an area to the rear left of vehicle 1, and an area to the rear right of vehicle 1. For instance, camera group 3 includes a camera that images the area behind vehicle 1, a camera that images the area to the rear left of vehicle 1, and a camera that images the area to the rear right of vehicle 1. The camera that images an area behind vehicle 1 is on the rear of vehicle 1. The camera that images the area to the rear left of vehicle 1 is on, for example, the left front door of vehicle 1, and images an area to the left of vehicle 1 and the area to the rear left of vehicle 1. The camera that images the area to the rear right of vehicle 1 is on, for example, the right front door of vehicle 1, and images an area to the right of vehicle 1 and the area to the rear right of vehicle 1.

Sensor group 4 detects vehicle information for use in determining a driving status of vehicle 1. For instance, sensor group 4 includes an acceleration sensor that detects acceleration of vehicle 1, a steering angle sensor that detects the steering angle of a steering wheel of vehicle 1, a direction indicator sensor that detects whether a direction indicator of vehicle 1 is on or off, and a shift sensor that detects the position of a shift lever of vehicle 1.

Navigation system 5 calculates and displays, for example, a route from the current location of vehicle 1 to the destination, to navigate vehicle 1.

Display control device 10 includes image obtainer 11, driving status determiner 12, obtainer 13, determiner 14, controller 15, and image outputter 16. For instance, image obtainer 11, driving status determiner 12, obtainer 13, determiner 14, controller 15, and image outputter 16 are achieved using a processor, memory, and so forth.

Image obtainer 11 obtains a captured image from camera group 3. Specifically, image obtainer 11 obtains, for example, a captured image of a rearward area of vehicle 1, a captured image of an area to the rear left of vehicle 1, and a captured image of an area to the rear right of vehicle 1. For instance, image obtainer 11 is communicably connected to camera group 3, either wired or wirelessly, and obtains captured images captured by camera group 3 from camera group 3.

Driving status determiner 12 obtains the vehicle information from sensor group 4 and navigation system 5, and determines the driving status of vehicle 1 on the basis of the vehicle information. For instance, driving status determiner 12 is communicably connected to sensor group 4 and navigation system 5, either wired or wirelessly, and obtains the vehicle information from sensor group 4 and navigation system 5.

For instance, the vehicle information includes acceleration of vehicle 1, the steering angle of the steering wheel of vehicle 1, an on/off state of each direction indicator of vehicle 1, the position of the shift lever of vehicle 1, and a route from the current location of vehicle 1 to the destination.

Moreover, the driving status is, for example, a state in which the vehicle is about to move forward, a state in which the vehicle is about to move to the left, a state in which the vehicle is about to move to the right, a state in which the vehicle is about to move backward, or a state in which the vehicle is stationary. The state in which the vehicle is about to move to the left is, for example, a state in which the vehicle is about to turn left or a state in which the vehicle is about to change lanes to the left. The state in which the vehicle is about to move to the right is, for example, a state in which the vehicle is about to turn right or a state in which the vehicle is about to change lanes to the right.

For instance, when the acceleration of vehicle 1 to one side in the lateral direction is greater than or equal to a predetermined value, driving status determiner 12 determines that vehicle 1 is about to move to the other side in the lateral direction. That is, when leftward acceleration of vehicle 1 is greater than or equal to the predetermined value, driving status determiner 12 determines that vehicle 1 is about to move to the right. When rightward acceleration of vehicle 1 is greater than or equal to the predetermined value, driving status determiner 12 determines that vehicle 1 is about to move to the left.

Moreover, when the steering angle to the one side in the lateral direction of the steering wheel of vehicle 1 is greater than or equal to a predetermined value, driving status determiner 12 determines that vehicle 1 is about to move to the one side in the lateral direction. That is, when the leftward steering angle of the steering wheel of vehicle 1 is greater than or equal to the predetermined value, driving status determiner 12 determines that vehicle 1 is about to move to the left. When the rightward steering angle of the steering wheel of vehicle 1 is greater than or equal to the predetermined value, driving status determiner 12 determines that vehicle 1 is about to move to the right.

Moreover, when a direction indicator on the one side in the lateral direction of vehicle 1 is switched on, driving status determiner 12 determines that vehicle 1 is about to move to the one side in the lateral direction of vehicle 1. That is, when a direction indicator on the left side of vehicle 1 is switched on, driving status determiner 12 determines that vehicle 1 is about to move to the left. When a direction indicator on the right side of vehicle 1 is switched on, driving status determiner 12 determines that vehicle 1 is about to move to the right.

Moreover, when the shift lever of vehicle 1 is in the reverse position, driving status determiner 12 determines that vehicle 1 is about to move backward.

Moreover, when vehicle 1 is travelling in a predetermined area including a left-turn location on the route from the current location of vehicle 1 to the destination, driving status determiner 12 determines that vehicle 1 is about to move to the left. When vehicle 1 is travelling in a predetermined area including a right-turn location on the route, driving status determiner 12 determines that vehicle 1 is about to move to the right.

Moreover, in other cases, driving status determiner 12 determines that vehicle 1 is about to move forward or that vehicle 1 is stationary.

Obtainer 13 obtains a driving status of vehicle 1. In the embodiment, obtainer 13 obtains the driving status determined by driving status determiner 12. It should be noted that display control device 10 need not include driving status determiner 12, and obtainer 13 may obtain a driving status determined externally to display control device 10.

On the basis of the driving status obtained by obtainer 13, determiner 14 determines whether to enlarge a first image cropped from a captured image of a rearward area of vehicle 1 and displayed on display 2 located in vehicle 1. The captured image of the rearward area of vehicle 1 is an image captured by camera group 3.

For instance, when vehicle 1 is about to move to the left or the right, determiner 14 determines that the first image displayed on display 2 located in vehicle 1 is to be enlarged. Meanwhile, when vehicle 1 is not about to move to the left or the right, determiner 14 determines that the first image displayed on display 2 located in vehicle 1 is not to be enlarged.

When determiner 14 determines that the first image is to be enlarged, controller 15 enlarges the first image by enlarging a cropping area to crop the first image from the captured image of the rearward area of vehicle 1, and causes display 2 to display the enlarged first image.

When determiner 14 does not determine that the first image is to be enlarged, the first image is cropped from the captured image by using a standard cropping area, and the cropped first image is displayed on display 2. The standard cropping area is determined according to, for example, the size of display 2. The standard cropping area may be predetermined by a user or may be determined by controller 15. For instance, when the first image is to be displayed on display 2a, the standard cropping area is an area that allows the first image to be displayed on entire display 2a. In this case, the first image cropped from the captured image by using the standard cropping area is displayed on entire display 2a. It should be noted that when the standard cropping area used in displaying the first image on display 2a may be an area that allows the first image to be displayed on a portion of display 2a rather than on entire display 2a. In this case, the first image cropped from the captured image by using the standard cropping area is displayed on the portion of display 2a.

When determiner 14 determines that the first image is to be enlarged, controller 15 enlarges the first image by enlarging the cropping area to be larger than the standard cropping area. A method for enlarging the cropping area is determined according to, for example, the size of the captured image and the size and location of display 2. The method for enlarging the cropping area may be predetermined by a user or may be determined by controller 15. For instance, when display 2a is displaying the first image, if there is a display adjacent to display 2a in the lateral direction, the method is determined to enlarge the cropping area as much as possible to the left, within the range of the captured image and the displayable area of display 2. Moreover, when display 2a is displaying the first image, if there is a display adjacent to display 2a in the vertical direction, the method is determined to enlarge the cropping area as much as possible to the lower side, within the range of captured image and the displayable area of display 2. It should be noted that instead of enlarging the cropping area as much as possible, the cropping area may be enlarged by a predetermined amount.

When determiner 14 determines that the first image is to be enlarged, controller 15 generates the enlarged first image as a result of cropping the first image from the captured image using a cropping area larger than the standard cropping area. Controller 15 causes image outputter 16 to output the enlarged first image to display 2, and causes display 2 to display the enlarged first image. The scale of the first image enlarged by controller 15 and displayed on display 2 is the same as that of the first image that had been displayed on display 2 before the first image was enlarged by controller 15.

Image outputter 16 outputs the first image generated by controller 15 and so forth to display 2.

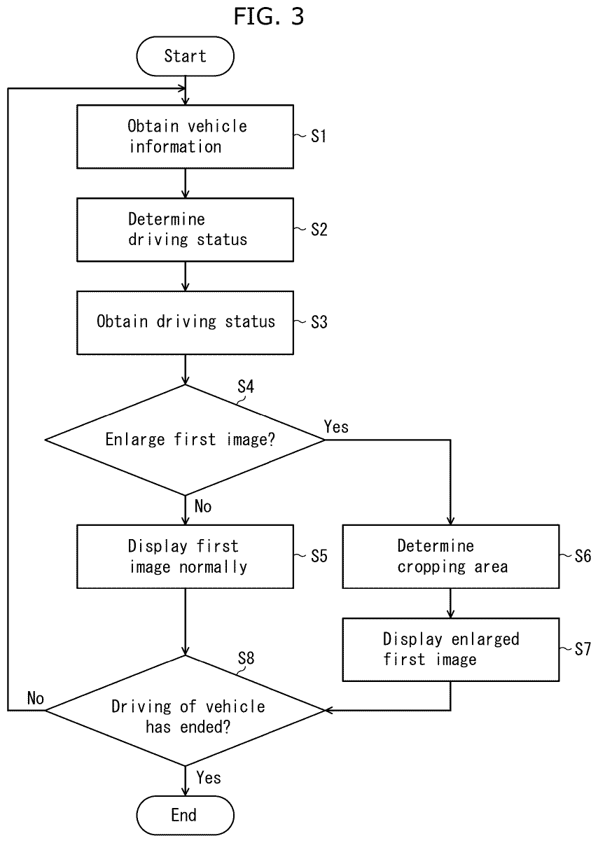

FIG. 3 is a flowchart illustrating an example of a display control method performed by display control device 10 in FIG. 1. Next, an example of the display control method performed by display control device 10 in FIG. 1 is described with reference to FIG. 3.

As illustrated in FIG. 3, driving status determiner 12 obtains vehicle information on vehicle 1 (step S1), and determines the driving status of vehicle 1 on the basis of the vehicle information (step S2). For instance, in the manner described above, driving status determiner 12 determines the driving status of vehicle 1.

Obtainer 13 obtains the driving status determined by driving status determiner 12 (obtainment step) (step S3).

On the basis of the driving status obtained by obtainer 13, determiner 14 determines whether to enlarge the first image cropped from the captured image of the rearward area of vehicle 1 and displayed on display 2 located in vehicle 1 (determination step) (step S4). For instance, in the manner described above, determiner 14 determines whether to enlarge the first image displayed on display 2 located in vehicle 1.

When determiner 14 determines that the first image is not to be enlarged (No in step S4), controller 15 causes display 2 to display the first image normally, without enlarging the first image displayed on display 2 (step S5). To cause display 2 to display the first image normally means to cause display 2 to display the first image cropped from the captured image by using the standard cropping area.

When determiner 14 determines that the first image is to be enlarged (Yes in step S4), controller 15 determines the cropping area (step S6). For instance, in the manner described above, controller 15 determines the cropping area, and enlarges the cropping area to be larger than the standard cropping area.

Controller 15 enlarges the first image by enlarging the cropping area to crop the first image from the captured image, and causes display 2 to display the enlarged first image (control step) (step S7). For instance, in the manner described above, controller 15 causes display 2 to display the enlarged first image.

Controller 15 determines whether driving of vehicle 1 has ended (step S8). When determining that the driving of vehicle 1 has not ended (No in step S8), controller 15 obtains vehicle information again (step S1). When determining that the driving of vehicle 1 has ended (Yes in step S8), controller 15 ends processing.

When determiner 14 determines that the first image is to be enlarged (Yes in step S4), the enlarged first image is displayed (step S7). After that, when determiner 14 determines that the first image is not to be enlarged (No in step S4), controller 15 causes the first image to be displayed normally, by setting the cropping area to the standard cropping area (step S5).

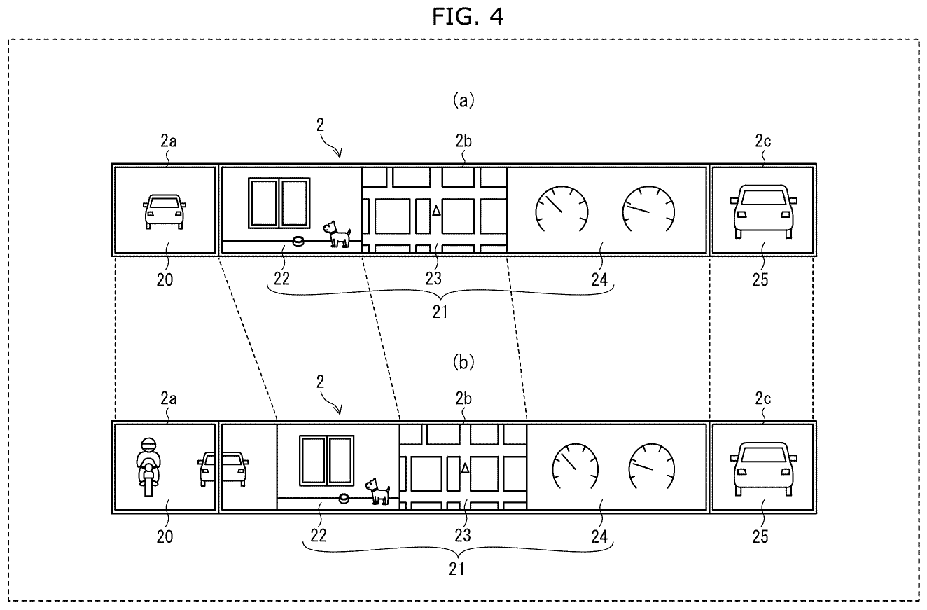

FIGS. 4 to 12 are figures for explaining first to ninth operation examples of display control device 10 in FIG. 1. Next, the first to ninth operation examples of display control device 10 are described with reference to FIGS. 4 to 12.

It should be noted that as illustrated in FIGS. 4 to 9, when display 2 is located in vehicle 1, display control device 10 performs one of the first to sixth operation examples. Which of the first to sixth operation examples to perform may be predetermined by, for example, a user, and may be determined by display control device 10 according to, for example, the type of image 21.

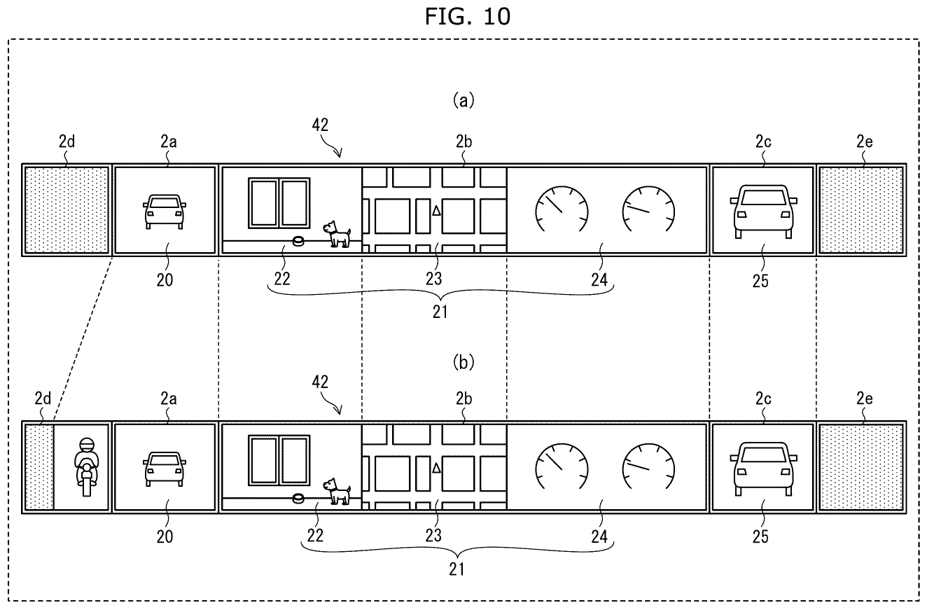

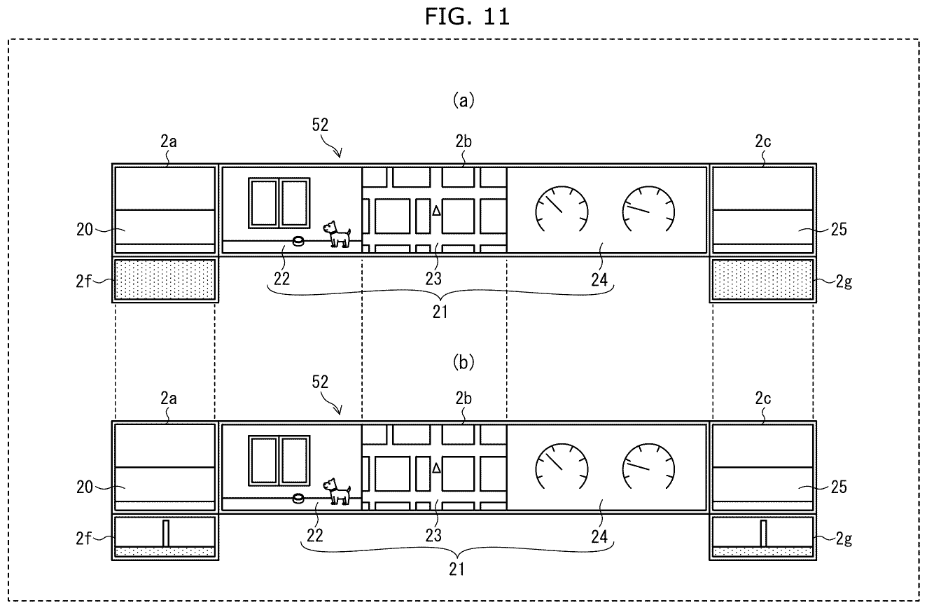

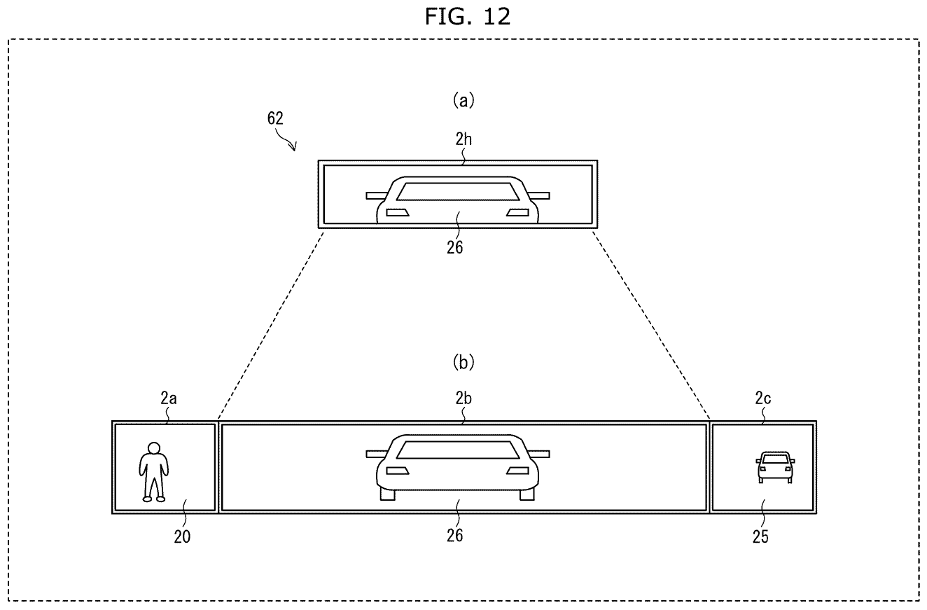

Moreover, as illustrated in FIG. 10, when display 42 is located in vehicle 1, display control device 10 performs the seventh operation example. As illustrated in FIG. 11, when display 52 is located in vehicle 1, display control device 10 performs the eighth operation example. As illustrated in FIG. 12, when display 62 is located in vehicle 1, display control device 10 performs the ninth operation example.
(a) in FIG. 4 illustrates a state before image 20 is enlarged (normal display), and (b) in FIG. 4 illustrates a state after image 20 is enlarged. First, the first operation example of display control device 10 is described with reference to FIG. 4.

As illustrated (a) in FIG. 4, display 2 is displaying image 20 cropped from a captured image of a rearward area of vehicle 1. Here, image 20 is an image cropped from a captured image of an area to the rear left of vehicle 1 and displayed on display 2a. Image 20 is displayed on entire display 2a.

Moreover, display 2 is displaying image 21. Here, image 21 displayed on display 2b is not an image cropped from the captured image of the rearward area of vehicle 1. Image 21 includes image 22, image 23, and image 24. Image 22, image 23, and image 24 are arranged in the lateral direction. Image 21 is displayed on entire display 2b.

Moreover, display 2 is displaying image 25 cropped from a captured image of a rearward area of vehicle 1. Here, image 25 is an image cropped from a captured image of an area to the rear right of vehicle 1, and is displayed on display 2c. Image 25 is displayed on entire display 2c.

On the basis of the driving status obtained by obtainer 13, determiner 14 determines whether to enlarge image 20 cropped from the captured image of the rearward area of vehicle 1 and displayed on display 2 located in vehicle 1 (step S4 in FIG. 3). Here, when vehicle 1 is about to move to the left, determiner 14 determines that image 20 displayed on display 2a is to be enlarged (Yes in step S4 in FIG. 3).

As illustrated in (b) in FIG. 4, when determiner 14 determines that image 20 is to be enlarged, controller 15 enlarges image 20 by enlarging the cropping area to crop image 20 from the captured image, and causes display 2 to display enlarged image 20 (step S7 in FIG. 3). Here, controller 15 enlarges image 20 by extending the cropping area to the left. Then, controller 15 causes enlarged image 20 to be displayed across display 2a and display 2b by causing display 2b as well as display 2a to display enlarged image 20. This improves visibility to further left compared to before image 20 was enlarged.

Here, when enlarged image 20 is to be displayed across display 2a and display 2b, controller 15 reduces image 21 by shrinking entire image 21 in the lateral direction, and causes reduced image 21 to be displayed on a region, within display 2b, where image 20 is not displayed. In this way, each of image 22, image 23, and image 24 is shrunk in the lateral direction.

It should be noted that although not illustrated in the figure, on the basis of the driving status obtained by obtainer 13, determiner 14 determines whether to enlarge image 25 cropped from the captured image of the rearward area of vehicle 1 and displayed on display 2 located in vehicle 1 (step S4 in FIG. 3). Here, when vehicle 1 is about to move to the right, determiner 14 determines that image 25 displayed on display 2c is to be enlarged (Yes in step S4 in FIG. 3).

When determiner 14 determines that image 25 is to be enlarged, controller 15 enlarges image 25 by enlarging the cropping area to crop image 25 from the captured image, and causes display 2 to display enlarged image 25 (step S7 in FIG. 3). Here, controller 15 enlarges image 25 by extending the cropping area to the right. Then, controller 15 causes enlarged image 25 to be displayed across display 2c and display 2b by causing display 2b as well as display 2c to display enlarged image 25. This improves visibility to further right compared to before image 25 was enlarged.

Here, when enlarged image 25 is to be displayed across display 2c and display 2b, controller 15 reduces image 21 by shrinking entire image 21 in the lateral direction, and causes reduced image 21 to be displayed on a region, within display 2b, where image 25 is not displayed. In this way, each of image 22, image 23, and image 24 is shrunk in the lateral direction.

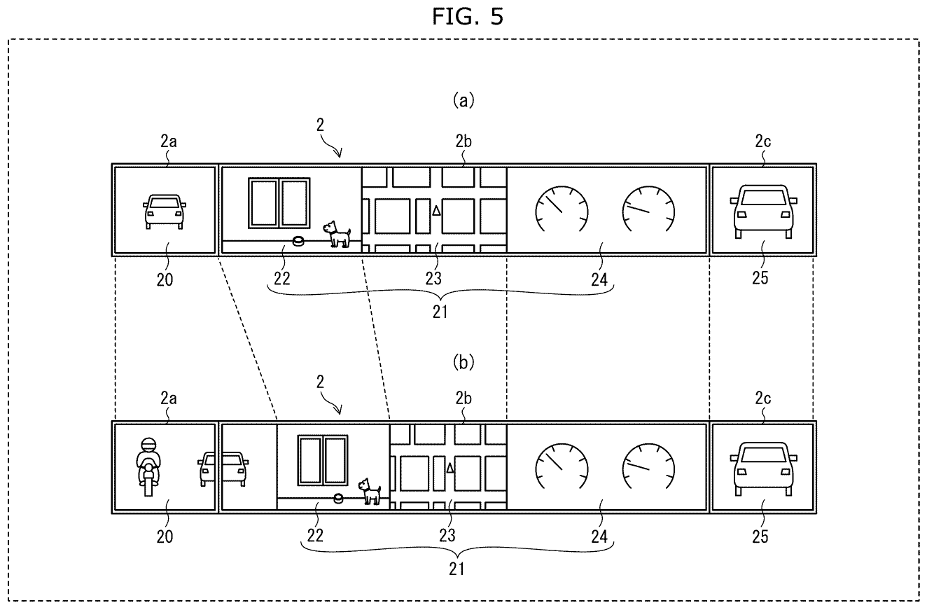

In this way, display control device 10 performs processing on image 25 in the same way as on image 20. The same applies to the second to sixth operation examples illustrated in FIGS. 5 to 9.

Display control device 10 according to the embodiment includes: obtainer 13 that obtains a driving status of vehicle 1; determiner 14 that determines, based on the driving status obtained by obtainer 13, whether to enlarge image 20 (or image 25) (a first image) cropped from a captured image of a rearward area of vehicle 1 and displayed on display 2 located in vehicle 1; and controller 15 that, when determiner 14 determines that image 20 (or image 25) is to be enlarged, enlarges a cropping area to crop image 20 (or image 25) from the captured image, and causes display 2 to display enlarged image 20 (or image 25).

In this way, it is possible to enlarge image 20 (or image 25) by enlarging the cropping area to crop image 20 (or image 25) from the captured image of the rearward area of vehicle 1, and display enlarged image 20 (or image 25) on display 2. Thus, it is possible to see a wider view of the rearward area of vehicle 1, which makes it easier to check the rearward area of vehicle 1.

Moreover, in display control device 10 according to the embodiment, the captured image is an image of an area to the rear left (or rear right) of vehicle 1 in the lateral direction of vehicle 1. Display 2 includes display 2a (or display 2c) (a first display) that is located in front of a driver's seat in vehicle 1 in the longitudinal direction of vehicle 1 and located to the left (or the right) of a central area in the lateral direction, and displays an image viewable from the driver's seat. When vehicle 1 is about to move to the left (or the right), determiner 14 determines that image 20 (image 25) displayed on display 2a (or display 2c) is to be enlarged. When determiner 14 determines that image 20 (or image 25) is to be enlarged, controller 15 enlarges image 20 (or image 25) by enlarging the cropping area, and causes display 2a (or display 2c) to display enlarged image 20 (or image 25).

In this way, when vehicle 1 is about to move to the left (or the right), it is possible to display enlarged image 20 (or image 25) on display 2a (or display 2c). Thus, when vehicle 1 is about to move to the left (or the right), it is possible to easily see a wider view of the area to the rear left (or the rear right) of vehicle 1, which makes it even easier to check the rearward area of vehicle 1.

Moreover, in display control device 10 according to the embodiment, display 2 includes display 2b (a second display) that is located to the right (or the left) of display 2a (or display 2c) in the lateral direction and located in the central area, and displays an image viewable from the driver's seat. When vehicle 1 is about to move to the left (or the right), determiner 14 determines that image 20 (or image 25) displayed on display 2a (or display 2c) is to be enlarged. When determiner 14 determines that image 20 (or image 25) is to be enlarged, controller 15 enlarges image 20 (or image 25) by extending the cropping area to the left (or the right), and causes enlarged image 20 (or image 25) to be displayed across display 2a (or display 2c) and display 2b.

In this way, when vehicle 1 is about to move to the left (or the right), it is possible to display enlarged image 20 (or image 25) across display 2a (or display 2c) and display 2b. Thus, when vehicle 1 is about to move to the left (or the right), it is possible to more easily see a wider view of the area to the rear left (or the rear right) of vehicle 1, which makes it even easier to check the rearward area of vehicle 1.

Moreover, in display control device 10 according to the embodiment, when enlarged image 20 (or image 25) is to be displayed across display 2a (or display 2c) and display 2b, if display 2b is displaying image 21 (a second image), controller 15 reduces image 21 by shrinking entire image 21 in the lateral direction, and causes reduced image 21 to be displayed on a region, within display 2b, where image 20 (or image 25) is not displayed.

In this way, image 21 as well as enlarged image 20 (or image 25) can be displayed without removing image 21. Thus, it is possible to suppress the amount of information obtained from image 21 from decreasing and make it easier to check the rearward area of vehicle 1.

Moreover, in a display control method according to the embodiment includes: obtaining a driving status of vehicle 1 (step S1); determining, based on the driving status obtained in the obtaining, whether to enlarge image 20 (or image 25) cropped from a captured image of a rearward area of vehicle 1 and displayed on display 2 located in vehicle 1 (step S4); when the determining determines that image 20 (or image 25) is to be enlarged, enlarging image 20 (or image 25) by enlarging a cropping area to crop image 20 (image 25) from the captured image, and causing display 2 to display enlarged image 20 (or image 25) (step S7).

The display control method has an advantage similar to that of display control device 10 described above.

Moreover, a program according to the embodiment is a program for causing a computer to execute the above display control method.

The program has an advantage similar to that of display control device 10 described above.
(a) in FIG. 5 illustrates a state before image 20 is enlarged (normal display), and (b) in FIG. 5 illustrates a state after image 20 is enlarged. Next, the second operation example of display control device 10 is described with reference to FIG. 5.

The second operation example differs from the first operation example mainly in the following points.

As illustrated in (b) in FIG. 5, when enlarged image 20 is to be displayed across display 2a and display 2b, controller 15 reduces image 21 by shrinking a portion of image 21 in the lateral direction, and causes reduced image 21 to be displayed on a region, within display 2b, where image 20 is not displayed. Here, among image 22, image 23, and image 24, controller 15 shrinks image 22 and image 23 with a lower priority in the lateral direction. For instance, priority is predetermined by, for example, a user.

It should be noted that although not illustrated in the figure, the same is true when enlarged image 25 is to be displayed across display 2c and display 2b.

In display control device 10 according to the embodiment, when enlarged image 20 (or image 25) is to be displayed across display 2a (or display 2c) and display 2b, if display 2b is displaying image 21 (the second image), controller 15 reduces image 21 by shrinking a portion of image 21 in the lateral direction, and causes reduced image 21 to be displayed on a region, within display 2b, where image 20 (or image 25) is not displayed.

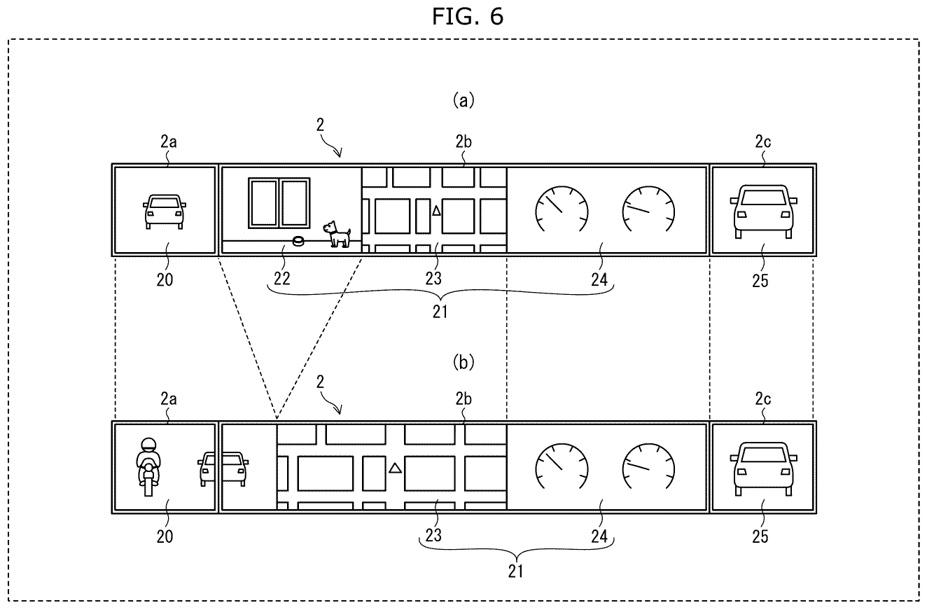

In this way, image 21 as well as enlarged image 20 (or image 25) can be displayed without removing image 21. Thus, it is possible to suppress the amount of information obtained from image 21 from decreasing and make it easier to check the rearward area of vehicle 1.
(a) in FIG. 6 illustrates a state before image 20 is enlarged (normal display), and (b) in FIG. 6 illustrates a state after image 20 is enlarged. Next, the third operation example of display control device 10 is described with reference to FIG. 6.

The third operation example differs from the first operation example mainly in the following points.

As illustrated in (b) in FIG. 6, when enlarged image 20 is to be displayed across display 2a and display 2b, controller 15 reduces image 21 by removing a portion of image 21 from display 2b, and causes reduced image 21 to be displayed on a region, within display 2b, where image 20 is not displayed. Here, controller 15 removes image 22 with the lowest priority among image 22, image 23, and image 24. For instance, priority is predetermined by, for example, a user. Moreover, by enlarging image 23 in the lateral direction, controller 15 causes image 21 to be displayed on the entire region of display 2b where image 20 is not displayed.

It should be noted that although not illustrated in the figure, the same is true when enlarged image 25 is to be displayed across display 2c and display 2b.

In display control device 10 according to the embodiment, when enlarged image 20 (or image 25) is to be displayed across display 2a (or display 2c) and display 2b, if display 2b is displaying image 21, controller 15 reduces image 21 by removing a portion of image 21 from display 2b, and causes reduced image 21 to be displayed on a region, within display 2b, where image 20 (or image 25) is not displayed.

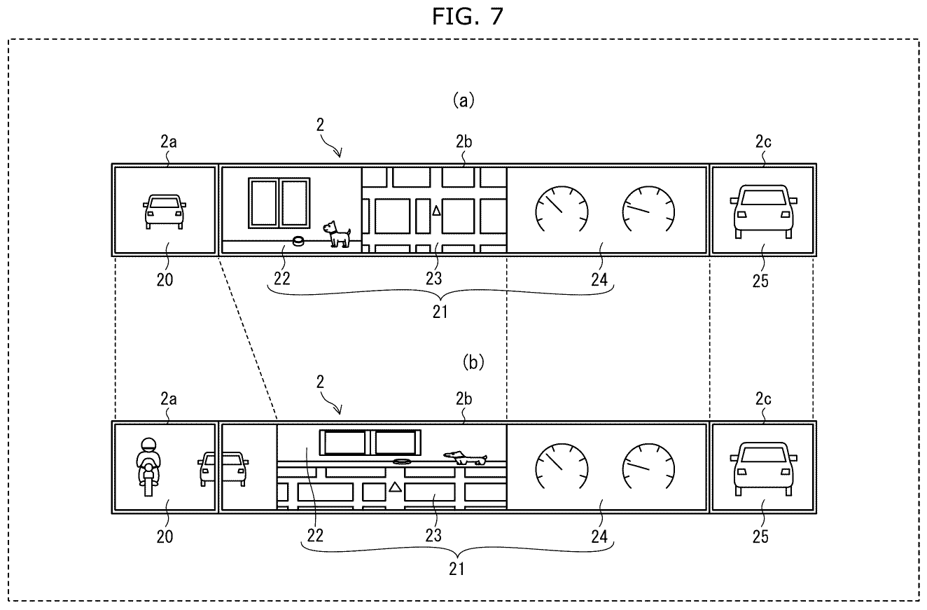

In this way, image 21 as well as enlarged image 20 (or image 25) can be displayed without reducing the scale of an unremoved portion of image 21. Thus, it is possible to easily see the unremoved portion of image 21 and make it easier to check the rearward area of vehicle 1.
(a) in FIG. 7 illustrates a state before image 20 is enlarged (normal display), and (b) in FIG. 7 illustrates a state after image 20 is enlarged. Next, the fourth operation example of display control device 10 is described with reference to FIG. 7.

The fourth operation example differs from the first operation example mainly in the following points.

As illustrated in (b) in FIG. 7, when enlarged image 20 is to be displayed across display 2a and display 2b, controller 15 reduces image 21 by shrinking image 22 and image 23 in the vertical direction of vehicle 1 and arranging image 22 and image 23 in the vertical direction, and causes reduced image 21 to be displayed on a region, within display 2b, where image 20 is not displayed. Here, among image 22, image 23, and image 24, controller 15 shrinks image 22 and image 23 with a lower priority in the vertical direction, and arranges image 22 and image 23 in the vertical direction. For instance, priority is predetermined by, for example, a user. Moreover, by extending in the lateral direction image 22 and image 23 shrunk in the vertical direction, controller 15 causes image 21 to be displayed on the entire region of display 2b where image 20 is not displayed.

It should be noted that although not illustrated in the figure, the same is true when enlarged image 25 is to be displayed across display 2c and display 2b.

In display control device 10 according to the embodiment, when enlarged image 20 (or image 25) is to be displayed across display 2a (or display 2c) and display 2b, if display 2b is displaying image 21 including image 22 and image 23 arranged in the lateral direction, controller 15 reduces image 21 by shrinking image 22 and image 23 in the vertical direction of vehicle 1 and arranging image 22 and image 23 in the vertical direction, and causes reduced image 21 to be displayed on a region, within display 2b, where image 20 (or image 25) is not displayed.

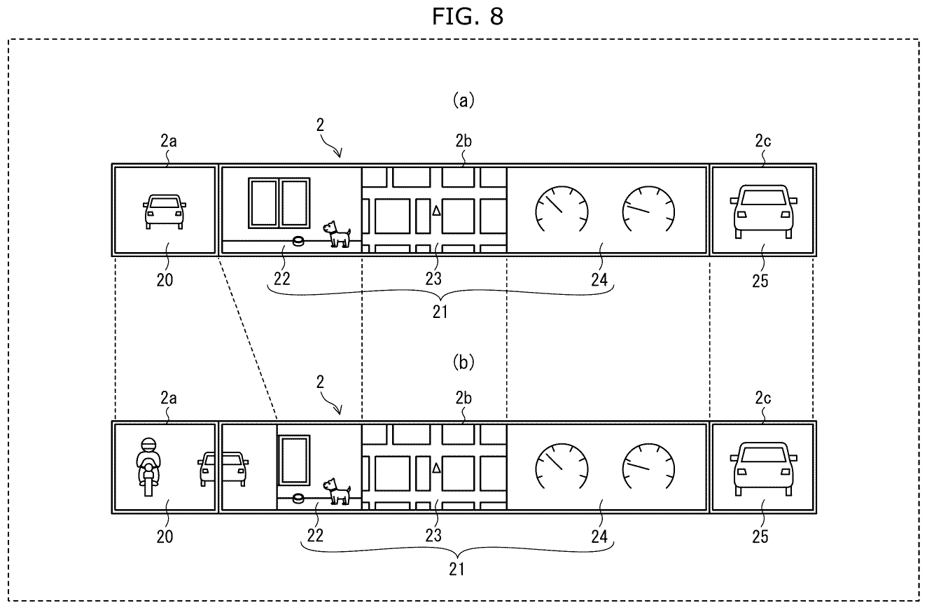

In this way, image 21 as well as enlarged image 20 (or image 25) can be displayed without removing image 21. Thus, it is possible to suppress the amount of information obtained from image 21 from decreasing and make it easier to check the rearward area of vehicle 1.
(a) in FIG. 8 illustrates a state before image 20 is enlarged (normal display), and (b) in FIG. 8 illustrates a state after image 20 is enlarged. Next, the fifth operation example of display control device 10 is described with reference to FIG. 8.

The fifth operation example differs from the first operation example mainly in the following points.

As illustrated in (b) in FIG. 8, when enlarged image 20 is to be displayed across display 2a and display 2b, controller 15 superimposes, onto image 21, a portion of enlarged image 20 that is to be displayed on display 2b, and causes display 2b to display image 21 on to which the portion is superimposed. Here, controller 15 superimposes, onto image 22, a portion of enlarged image 20 that is to be displayed on display 2b, and causes display 2b to display image 22 onto which the portion is superimposed. As a result, image 20 hides a portion of image 22.

It should be noted that although not illustrated in the figure, the same is true when enlarged image 25 is to be displayed across display 2c and display 2b.

In display control device 10 according to the embodiment, when enlarged image 20 (or image 25) is to be displayed across display 2a (or display 2c) and display 2b, if display 2b is displaying image 21, controller 15 superimposes, onto image 21, a portion of enlarged image 20 (or image 25) that is to be displayed on display 2b, and causes display 2b to display image 21 on to which the portion is superimposed.

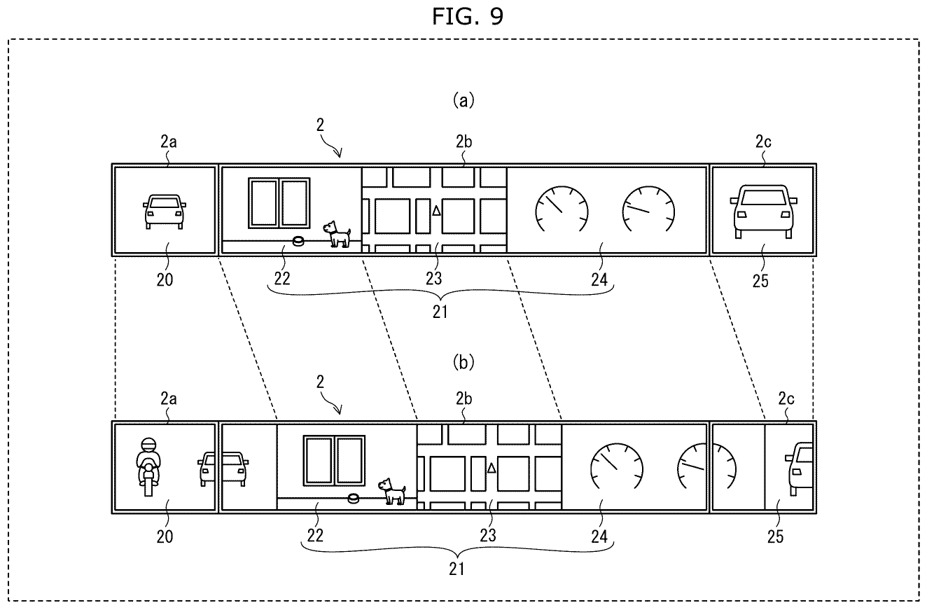

In this way, image 21 as well as enlarged image 20 (or image 25) can be displayed without reducing the scale of the portion of image 21 that is not superimposed with image 20 (or image 25). Thus, it is possible to easily see the portion of image 21 that is not superimposed with image 20 (or image 25), and make it easier to check the rearward area of vehicle 1.
(a) in FIG. 9 illustrates a state before image 20 is enlarged (normal display), and (b) in FIG. 9 illustrates a state after image 20 is enlarged. Next, the sixth operation example of display control device 10 is described with reference to FIG. 9.

The sixth operation example differs from the first operation example mainly in the following points.

As illustrated in (b) in FIG. 9, when enlarged image 20 is to be displayed across display 2a and display 2b, controller 15 causes image 21 to be displayed across display 2c and a region, within display 2b, where image 20 is not displayed. Moreover, controller 15 reduces image 25 by removing a portion of image 25 from display 2c, and causes reduced image 25 to be displayed on a region, within display 2c, where image 21 is not displayed. Here, controller 15 moves the right end of a cropping area to crop image 25 from the captured image, to the left side, to reduce the cropping area. In this way, controller 15 removes the portion of image 25 from display 2c. Image 25 is displayed on the entire region of display 2c where image 21 is not displayed.

It should be noted that although not illustrated in the figure, the same is true when enlarged image 25 is to be displayed across display 2c and display 2b.

In display control device 10 according to the embodiment, display 2 includes display 2c (or display 2a) (a third display) that is located to the right (or the left) of display 2b in the lateral direction, and displays an image viewable from the driver's seat. When enlarged image 20 (or image 25) is to be displayed across display 2a (or display 2c) and display 2b, if display 2b is displaying image 21, and display 2c (or display 2a) is displaying image 25 (or image 20) (a third image), controller 15 causes image 21 to be displayed across display 2c (or display 2a) and a region, within display 2b, where image 20 (or image 25) is not displayed, reduces image 25 (or image 20) by removing a portion of image 25 (or image 20) from display 2c (or display 2a), and causes reduced image 25 (image 20) to be displayed on a region, within display 2c (or display 2a), where image 21 is not displayed.

In this way, image 21 and image 25 (or image 20) as well as enlarged image 20 (or image 25) can be displayed without removing image 21 or reducing the scale of an unremoved portion of image 25 (or image 20). Thus, it is possible to suppress the amount of information obtained from image 21 from decreasing, easily see the unremoved portion of image 25 (or image 20), and make it easier to check the rearward area of vehicle 1.
(a) in FIG. 10 illustrates a state before image 20 is enlarged (normal display), and (b) in FIG. 10 illustrates a state after image 20 is enlarged. Next, the seventh operation example of display control device 10 is described with reference to FIG. 10.

Here, display 42 is located in vehicle 1 instead of display 2. Display 42 differs from display 2 mainly in the following points.

As illustrated in (a) in FIG. 10, display 42 includes display 2d that is located to the left of display 2a in the lateral direction and displays an image viewable from the driver's seat in vehicle 1. Moreover, display 42 includes display 2e that is located to the right of display 2c in the lateral direction and displays an image viewable from the driver's seat in vehicle 1. In display 2d, a display screen for displaying an image faces the driver's seat in vehicle 1. In display 2e, a display screen for displaying an image faces the driver's seat in vehicle 1. A right end portion of display 2d is adjacent to a left end portion of display 2a. A left end portion of display 2e is adjacent to a right end portion of display 2c. Display 2d is physically separate from display 2a, and display 2e is physically separate from display 2c.

The seventh operation example differs from the first operation example mainly in the following points.

As illustrated in (b) in FIG. 10, when determiner 14 determines that image 20 is to be enlarged, controller 15 enlarges image 20 by extending the cropping area to the left. Then, controller 15 causes enlarged image 20 to be displayed across display 2a and display 2d, by causing display 2d as well as display 2a to display enlarged image 20.

It should be noted that although not illustrated in the figure, when determiner 14 determines that image 25 is to be enlarged, controller 15 enlarges image 25 by extending the cropping area to the right. Then, controller 15 causes enlarged image 25 to be displayed across display 2c and display 2e by causing display 2e as well as display 2c to display enlarged image 25.

In display control device 10 according to the embodiment, display 42 includes display 2d (or display 2e) (a fourth display) that is located to the left (or the right) of display 2a (or display 2c) in the lateral direction and displays an image viewable from the driver's seat. When vehicle 1 is about to move to the left (or the right), determiner 14 determines that image 20 (or image 25) displayed on display 2a (or display 2c) is to be enlarged. When determiner 14 determines that image 20 (or image 25) is to be enlarged, controller 15 enlarges image 20 (or image 25) by extending the cropping area to the left (or the right), and causes enlarged image 20 (or image 25) to be displayed across display 2a (or display 2c) and display 2d (or display 2e).

In this way, when vehicle 1 is about to move to the left (or the right), it is possible to display enlarged image 20 (or image 25) across display 2a (or display 2c) and display 2d (or display 2e). Thus, when vehicle 1 is about to move to the left (or the right), it is possible to more easily see a wider view of the area to the rear left (or the rear right) of vehicle 1, which makes it even easier to check the rearward area of vehicle 1.
(a) in FIG. 11 illustrates a state before image 20 and image 25 are enlarged (normal display), and (b) in FIG. 11 illustrates a state after image 20 and image 25 are enlarged. Next, the eighth operation example of display control device 10 is described with reference to FIG. 11.

Here, display 52 is located in vehicle 1 instead of display 2. Display 52 differs from display 2 mainly in the following points.

As illustrated in (a) in FIG. 11, display 52 includes display 2f that is located below display 2a in the vertical direction and displays an image viewable from the driver's seat. Moreover, display 52 includes display 2g that is located below display 2c in the vertical direction and displays an image viewable from the driver's seat. In display 2f, a display screen for displaying an image faces the driver's seat in vehicle 1. In display 2g, a display screen for displaying an image faces the driver's seat in vehicle 1. An upper end portion of display 2f is adjacent to a lower end portion of display 2a. An upper end portion of display 2g is adjacent to a lower end portion of display 2c. Display 2f is physically separate from display 2a, and display 2g is physically separate from display 2c.

The eighth operation example differs from the first operation example mainly in the following points.

As illustrated in (a) in FIG. 11, when vehicle 1 is about to move backward, determiner 14 determines that image 20 displayed on display 2a is to be enlarged (Yes in step S4 in FIG. 3). Moreover, when vehicle 1 is about to move backward, determiner 14 determines that image 25 displayed on display 2c is to be enlarged (Yes in step S4 in FIG. 3).

As illustrated in (b) in FIG. 11, when determiner 14 determines that image 20 is to be enlarged, controller 15 enlarges image 20 by enlarging a cropping area, and causes display 2a to display enlarged image 20 (step S7 in FIG. 3). Here, controller 15 enlarges image 20 by extending the cropping area to the lower side. Then, controller 15 causes enlarged image 20 to be displayed across display 2a and display 2f by causing display 2f as well as display 2a to display enlarged image 20. This improves visibility to further left and lower side compared to before image 20 was enlarged, which makes it easier to see a white line drawn on the ground and so forth.

Moreover, when determiner 14 determines that image 25 is to be enlarged, controller 15 enlarges image 25 by enlarging a cropping area, and causes display 2c to display enlarged image 25 (step S7 in FIG. 3). Here, controller 15 enlarges image 25 by extending the cropping area to the lower side. Then, controller 15 causes enlarged image 25 to be displayed across display 2c and display 2g by causing display 2g as well as display 2c to display enlarged image 25. This improves visibility to further right and lower side compared to before image 20 was enlarged, which makes it easier to see a white line drawn on the ground and so forth.

It should be noted that when display 52 is located in vehicle 1, when vehicle 1 is about to move to the left or the right, display control device 10 may perform one of the first to sixth operation examples.

In display control device 10 according to the embodiment, the captured image is an image of an area to the rear left (or rear right) of vehicle 1 in the lateral direction of vehicle 1. Display 2 includes display 2a (or display 2c) (the first display) that is located in front of the driver's seat in vehicle 1 in the longitudinal direction of vehicle 1 and located to the left (or the right) of the central area in the lateral direction, and displays an image viewable from the driver's seat. When vehicle 1 is about to move backward, determiner 14 determines that image 20 (image 25) displayed on display 2a (or display 2c) is to be enlarged. When determiner 14 determines that image 20 (or image 25) is to be enlarged, controller 15 enlarges image 20 (or image 25) by enlarging a cropping area, and causes display 2a (or display 2c) to display enlarged image 20 (or image 25).

In this way, when vehicle 1 is about to move backward, it is possible to display enlarged image 20 (or image 25) on display 2a (or display 2c). Thus, when vehicle 1 is about to move to the left (or the right), it is possible to easily see a wider view of an area to the rear left (or the rear right) of vehicle 1, which makes it even easier to check the rearward area of vehicle 1.

Moreover, in display control device 10 according to the embodiment, display 52 includes display 2f (or display 2g) (a fifth display) that is located on the lower side of display 2a (or display 2c) in the vertical direction of vehicle 1 and displays an image viewable from the driver's seat. When vehicle 1 is about to move backward, determiner 14 determines that image 20 (or image 25) displayed on display 2a (or display 2c) is to be enlarged. When determiner 14 determines that image 20 (or image 25) is to be enlarged, controller 15 enlarges image 20 (or image 25) by extending the cropping area to the lower side, and causes enlarged image 20 (or image 25) to be displayed across display 2a (or display 2c) and display 2f (or display 2g).

In this way, when vehicle 1 is about to move backward, it is possible to display enlarged image 20 (or image 25) across display 2a (or display 2c) and display 2f (or display 2g). Thus, when vehicle 1 is about to move backward, it is possible to more easily see a wider view of the area to the rear left (or the rear right) of vehicle 1, which makes it even easier to check the rearward area of vehicle 1.
(a) in FIG. 12 illustrates display 2h, and (b) in FIG. 12 illustrates display 2a, display 2b, and display 2c. Next, the ninth operation example of display control device 10 is described with reference to FIG. 12.

Here, display 62 is located in vehicle 1 instead of display 2. Display 62 differs from display 2 mainly in the following points.

As illustrated in FIG. 12, display 62 includes display 2h that is located in front of the driver's seat in vehicle 1 in the longitudinal direction, located in the central area in the lateral direction of vehicle 1, located above display 2b in the vertical direction of vehicle 1, is smaller than display 2b, and displays an image viewable from the driver's seat. In display 2h, a display screen for displaying an image faces the driver's seat in vehicle 1. For instance, display 2h is an electronic rear-view mirror.

The ninth operation example differs from the first operation example mainly in the following points.

When vehicle 1 is about to move backward, determiner 14 determines that image 26 displayed on display 2h is to be enlarged (Yes in step S4 in FIG. 3). Here, a captured image is an image of a rearward area of vehicle 1, and image 26 is an image cropped from the captured image.

When determiner 14 determines that image 26 is to be enlarged, controller 15 enlarges image 26 by enlarging a cropping area, and causes display 2b to display enlarged image 26 (step S7 in FIG. 3). For instance, controller 15 enlarges image 26 by extending the cropping area to the left, to the right, and to the lower side. This further improves visibility to the left, to the right, and to the lower side compared to before image 26 was enlarged.

It should be noted that when display 62 is located in vehicle 1, when vehicle 1 is about to move to the left or the right, display control device 10 may perform one of the first to sixth operation examples.

In display control device 10 according to the embodiment, the captured image is an image of a rearward area of vehicle 1. Display 62 includes: display 2b (a sixth display) that is located in front of the driver's seat in vehicle 1 in the longitudinal direction of vehicle 1 and located in the central area in the lateral direction of vehicle 1, and displays an image viewable from the driver's seat; and display 2h (a seventh display) that is located in front of the driver's seat in the longitudinal direction, located in the central area, and located above display 2b in the vertical direction of vehicle 1, is smaller than display 2b, and displays an image viewable from the driver's seat. When vehicle 1 is about to move backward, determiner 14 determines that image 26 (the first image) displayed on display 2h is to be enlarged. When determiner 14 determines that image 26 is to be enlarged, controller 15 enlarges image 26 by enlarging the cropping area, and causes display 2b to display enlarged image 26.

In this way, when vehicle 1 is about to move backward, it is possible to display enlarged image 26 on display 2b. Thus, when vehicle 1 is about to move backward, it is possible to easily see a wider view of the rearward area of vehicle 1, which makes it even easier to check the rearward area of vehicle 1.

While an embodiment has been described herein above, it is to be appreciated that various changes in form and detail may be made without departing from the spirit and scope of the present disclosure as presently or hereafter claimed.

### Other Embodiments

Although the display control device and so forth according to one or more aspects are described above on the basis of the embodiment, the present disclosure is not limited to the embodiment. The scope of the present disclosure encompasses embodiments obtained by adding various changes envisioned by those skilled in the art to the embodiment, as long as the resultant embodiments do not depart from the scope of the present disclosure.

In the above embodiment, a case where display 2 includes display 2a, display 2b, and display 2c is described as a non-limiting example. For instance, a display may include a single display into which display 2a, display 2b, and display 2c are incorporated. In this case, in the single display, display regions having a one-to-one correspondence with display 2a, display 2b, and display 2c are logically separated from each other. The same applies to displays 2a, 2b, 2c, 2d, and 2e in display 42, displays 2a, 2b, 2c, 2f, and 2g in display 52, and displays 2a, 2b, and 2c in display 62.

Moreover, in the embodiment, displays 2, 42, 52, and 62 are described as a non-limiting example. For instance, a display may be configured by appropriately combining displays 2a, 2b, 2c, 2d, 2e, 2f, 2g, and 2h. Specifically, a display may be configured using all of displays 2a, 2b, 2c, 2d, 2e, 2f, 2g, and 2h. In this case, when vehicle 1 is about to move to the left or the right, display control device 10 may perform the seventh operation example. When vehicle 1 is about to move backward, display control device 10 may perform the eighth or ninth operation example.

It should be noted that in the above embodiment, each constituent element may be achieved as dedicated hardware or may be achieved by executing a software program suitable for the constituent element. Each constituent element may be achieved by a program executer, such as a central processing unit (CPU) or a processor, reading out and executing a software program stored in a recording medium, such as a hard disk or semiconductor memory. Here, software for achieving the device and so forth described in the above embodiment is a program for causing a computer to perform the steps included in the flowchart illustrated in FIG. 3

It should be noted that the present disclosure also encompasses the following cases.
(1) Each device described above is specifically a computer system including a microprocessor, ROM, RAM, a hard disk unit, a display unit, a keyboard, and a mouse. A computer program is stored in the RAM or hard disk unit. Functions of each device are achieved by the microprocessor operating in accordance with the computer program. Here, the computer program is constructed by combining instruction codes to command a computer to achieve a predetermined function.
(2) Some or all of constituent elements included in each device described above may be configured as a single system large scale integration (LSI). A system LSI is a super multifunctional LSI manufactured by integrating parts into one chip, and specifically a computer system including a microprocessor, ROM, and RAM. A computer program is stored in the RAM. Functions of the system LSI are achieved by the microprocessor operating in accordance with the computer program.
(3) Some or all of the constituent elements included in each device described above may be configured as an IC card or a single module detachable from and attachable to the device. The IC card or the module is a computer system including a microprocessor, ROM, and RAM. The IC card or the module may contain the above super multifunctional LSI. Functions of the IC card or the module are achieved by the microprocessor operating in accordance with the computer program. The IC card or the module may be tamper-resistant.
(4) The present disclosure may be the methods described above. Moreover, the present disclosure may be a computer program for achieving the methods using a computer, and may be a digital signal consisting of the computer program.

Moreover, the present disclosure may be the computer program or the digital signal stored in a computer-readable recording medium, such as a flexible disk, a hard disk, a CD-ROM, an MO, a DVD, a DVD-ROM, a DVD-RAM, a Blu-ray (registered trademark) Disc (BD), or semiconductor memory. Moreover, the present disclosure may be the digital signal recorded on these recording media.

Moreover, the present disclosure may relate to transmission of the computer program or the digital signal via, for example, a network or data broadcasting typified by a telecommunication line, a wireless or wired communication line, or the Internet.

Moreover, the present disclosure may be a computer system including a microprocessor and memory. The computer program may be stored in the memory, and the microprocessor may operate in accordance with the computer program.

Moreover, another independent computer system may be caused to perform the above by transferring the program or the digital signal recorded on the recording medium to the independent computer system or by transferring the program or the digital signal to the independent computer system via, for example, the network.
(5) The above embodiment and another embodiment may be combined.

### Further Information About Technical Background to This Application

The disclosures of the following patent applications including specification, drawings, and claims are incorporated herein by reference in their entirety: Japanese Patent Application No. 2023-148827 filed on Sep. 13, 2023, and PCT International Application No. PCT/JP2024/028448 filed on Aug. 8, 2024.

### INDUSTRIAL APPLICABILITY

The present disclosure is applicable to, for example, a device that controls display of an image on a display located in a vehicle.

1. A display control device comprising:
a processor; and
memory connected to the processor, wherein
using the memory, the processor:
obtains a driving status of a vehicle;
performs determination processing, based on the driving status obtained, for determining whether to enlarge a first image to generate an enlarged first image, the first image being cropped from a captured image of a rearward area of the vehicle and displayed on a display located in the vehicle; and
performs, when the determination processing determines that the first image is to be enlarged, display control to enlarge the first image by enlarging a cropping area to crop the first image from the captured image, and to display the enlarged first image on the display.

2. The display control device according to claim 1, wherein
the captured image is an image of a rearward area on one side in a lateral direction of the vehicle,
the display includes a first display that is located in front of a driver's seat in the vehicle in a longitudinal direction of the vehicle and located to the one side of a central area in the lateral direction, and displays an image viewable from the driver's seat,
in the determination processing, when the vehicle is about to move to the one side or is about to move backward, the processor determines that the first image displayed on the first display is to be enlarged, and
in the display control, when the determination processing determines that the first image is to be enlarged, the processor enlarges the first image by enlarging the cropping area, and causes the first display to display the enlarged first image.

3. The display control device according to claim 2, wherein
the display includes a second display that is located in the central area and located to an other side in the lateral direction of the first display, and displays an image viewable from the driver's seat,
in the determination processing, when the vehicle is about to move to the one side, the processor determines that the first image displayed on the first display is to be enlarged, and
in the display control, when the determination processing determines that the first image is to be enlarged, the processor enlarges the first image by extending the cropping area to the one side, and causes the enlarged first image to be displayed across the first display and the second display.

4. The display control device according to claim 3, wherein
in the display control, when the enlarged first image is to be displayed across the first display and the second display, if the second display is displaying a second image, the processor reduces the second image to generate a reduced second image by shrinking at least a portion of the second image in the lateral direction, and causes the reduced second image to be displayed on a region, within the second display, where the first image is not displayed.

5. The display control device according to claim 3, wherein
in the display control, when the enlarged first image is to be displayed across the first display and the second display, if the second display is displaying a second image, the processor reduces the second image to generate a reduced second image by removing a portion of the second image from the second display, and causes the reduced second image to be displayed on a region, within the second display, where the first image is not displayed.

6. The display control device according to claim 3, wherein
in the display control, when the enlarged first image is to be displayed across the first display and the second display, if the second display is displaying a second image including images arranged in the lateral direction, the processor reduces the second image to generate a reduced second image by shrinking the images in a vertical direction of the vehicle and arranging the images in the vertical direction, and causes the reduced second image to be displayed on a region, within the second display, where the first image is not displayed.

7. The display control device according to claim 3, wherein
in the display control, when the enlarged first image is to be displayed across the first display and the second display, if the second display is displaying a second image, the processor superimposes, onto the second image, a portion of the enlarged first image that is to be displayed on the second display, and causes the second display to display the second image onto which the portion is superimposed.

8. The display control device according to claim 3, wherein
the display includes a third display that is located to the other side in the lateral direction of the second display, and displays an image viewable from the driver's seat, and
in the display control, when the enlarged first image is to be displayed across the first display and the second display, if the second display is displaying a second image, and the third display is displaying a third image, the processor:
causes the second image to be displayed across the third display and a region, within the second display, where the first image is not displayed; and
reduces the third image to generate a reduced third image by removing a portion of the third image from the third display, and causes the reduced third image to be displayed on a region, within the third display, where the second image is not displayed.

9. The display control device according to claim 2, wherein
the display includes a fourth display that is located to the one side in the lateral direction of the first display, and displays an image viewable from the driver's seat,
in the determination processing, when the vehicle is about to move to the one side, the processor determines that the first image displayed on the first display is to be enlarged, and
in the display control, when the determination processing determines that the first image is to be enlarged, the processor enlarges the first image by extending the cropping area to the one side, and causes the enlarged first image to be displayed across the first display and the fourth display.

10. The display control device according to claim 2, wherein
the display includes a fifth display that is located on a lower side of the first display in a vertical direction of the vehicle, and displays an image viewable from the driver's seat,
in the determination processing, when the vehicle is about to move backward, the processor determines that the first image displayed on the first display is to be enlarged, and
in the display control, when the determination processing determines that the first image is to be enlarged, the processor enlarges the first image by extending the cropping area to the lower side, and causes the enlarged first image to be displayed across the first display and the fifth display.

11. The display control device according to claim 1, wherein
the captured image is an image of a rearward area of the vehicle,
the display includes:
a sixth display that is located in front of a driver's seat in the vehicle in a longitudinal direction of the vehicle and located in a central area in a lateral direction of the vehicle, and displays an image viewable from the driver's seat; and
a seventh display that is located in front of the driver's seat in the longitudinal direction, located in the central area, and located above the sixth display in a vertical direction of the vehicle, is smaller than the sixth display, and displays an image viewable from the driver's seat,
in the determination processing, when the vehicle is about to move backward, the processor determines that the first image displayed on the seventh display is to be enlarged, and
in the display control, when the determination processing determines that the first image is to be enlarged, the processor enlarges the first image by enlarging the cropping area, and causes the sixth display to display the enlarged first image.

12. A display control method performed by a computer, the display control method comprising:
obtaining a driving status of a vehicle;
determining, based on the driving status obtained, whether to enlarge a first image cropped from a captured image of a rearward area of the vehicle and displayed on a display located in the vehicle; and
when the determining determines that the first image is to be enlarged, enlarging the first image by enlarging a cropping area to crop the first image from the captured image, and causing the display to display the first image enlarged.
